(19) United States
(12) Patent Application Publication
(10) Pub. No.: US 2016/0098807 A1
(43) Pub. Date: Apr. 7, 2016

(54) METHODS OF LEGACY PLANNING WITH GIFTS AND HEIRS' PROPERTY

(71) Applicant: A&G Family Trust, Rock Hill, SC (US)

(72) Inventor: Hamar A. Jones, Rock Hill, SC (US)

(73) Assignee: A&G FAMILY TRUST, Rock Hill, SC (US)

(21) Appl. No.: 14/507,250

(22) Filed: Oct. 6, 2014

(51) Int. Cl. G06Q 50/18; G06Q 10/06

(52) U.S. Cl. CPC G06Q 50/186; G06Q 10/06

(57) ABSTRACT

Methods of estate planning with gifts and heirs' property include estimating a likelihood of an organization receiving a gift from a last will & testament, providing an heirs' property family tree software program, or combinations thereof. The step of estimating a likelihood of an organization receiving a gift from a last will & testament includes estimating a life expectancy range, and estimating a likelihood of removing the organization from the last will & testament. The step of providing an heir property family tree software program includes formulating the distributions of heirs' property, and visually displaying the distributions in a family tree display.

### CROSS-REFERENCE TO RELATED APPLICATIONS

None

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE INVENTION

1. Technical Field of the Invention

The instant disclosure is directed toward methods of legacy planning with gifts and heirs' property, and more particularly to methods of legacy planning with gift expectancy calculations for groups and methods of legacy planning with heirs' property family trees.

2. Description of the Related Art

Legacy planning is the process of determining the values and legacy one wants to leave behind. Legacy planning may include the preparation of a last will & testament, living will, durable power of attorney (“POA”), etc., along with plans for gifts, donations, lifetime gifts/donations, the like, etc. Nationally, the average cost of a last will & testament, living will and POA is between $1,200 to $2,500, depending on the state where you live. These high costs may be problematic for certain individuals to do the necessary legacy planning they desire.

A lifetime donation is a solid option for donors who understand gifts made during a donor's life allow an immediate tax deduction on both federal and state levels. Secondly, this method of gifting provides immediate funds to organizations like churches to assist in their operation budgets. For example, lifetime donations may be paid over a 36-month period and paid monthly to minimize the administrative costs of making sure the donor is prompt.

Heirs' property is land held in common by the descendants (or heirs) of a landowner who has died without a last will & testament, or intestate, and their family members failed to probate the decedent's estate (to remove the title to the real property from the decedent's name unto his/her heirs at law/descendants). For example, after the Civil War, many African Americans were deeded land by others or purchased land for themselves. Because of laws against teaching slaves to read or write, and later Jim Crow laws restricting access to legal assistance, many of these new landowners did not leave written last will & testaments. A tradition of verbal bequeaths remains common today in the African American community. However, verbal bequests are not generally recognized by state law, resulting in heirs' property.

While many co-owners enjoy the flexibility heirs' property offers and the sense of community it fosters, the title to such property is usually considered clouded. Problems associated with holding land as heirs' property, such as forced tax and partition sales, often lead to land loss. Heirs' property is cited as one of the leading causes of land loss among African Americans. There are many misconceptions surrounding heirs' property and confusion often occurs about who owns what. It is important that heirs are aware of risks involved in heirs' property, know their rights as landowners, and take the proper steps to protect their land. Every single heir has a right to enjoy the benefits of landownership, but they also have the responsibility to ensure the land is cared for. Disadvantages of heirs' property may include: vulnerability to partition sales; vulnerability to tax sales; cannot secure a mortgage on the land; may not be eligible for federal funding for housing or repairs; may not be eligible for other programs that require clear title, like weatherization programs; difficulty getting the property annexed into a city; most timber companies will not purchase timber from land without a clear title; any improvements made to the land (agricultural improvements or building structures) become property of all heirs entitled to the land; difficulty leasing the land out for agricultural or recreational purposes; vulnerability to adverse possession; with each passing generation that dies without a last will & testament, the number of heirs increases while the size of each person's interest decreases; and/or if land is sold, many family members cannot afford to “buy out” other co-owners or out-bid developers or real estate speculators.

Heirs' property is the source of many legal and bureaucratic problems, yet remains an important resource for many families. It is important that families are aware of the dangers of keeping land in this pattern of ownership and what measures they can take to protect themselves. If policymakers, housing services, community planners, and economic development coordinators all became more aware of heirs' property and the issues involved, they can better serve their constituents by ensuring a more equitable distribution of assets. As such, there is clearly a need for helping people in understanding heirs' property in legacy planning.

Organizations like nonprofits, charities, and especially churches may rely on tithes and other financial contributions to operate, to extend their ministry and other benevolence endeavors. Viewed another way, these types of organizations like churches are businesses and their members or congregants are the shareholders of the company. When business is going well, the organization or church may not need their shareholders to contribute any additional funding aside from tithes; but if business is not going well, as shareholders, congregants may be required to make additional contributions. Every time a tithing congregant dies, the church's operating funds are affected. This has gone on for centuries in most communities and organizations, and is especially true for the African American community. As such, there is clearly a need for organizations, like churches, to encourage, promote, and provide means for members to contribute or donate when legacy planning.

As a result, there is clearly an unmet need for new methods of legacy planning with gifts and/or heirs' property. The instant disclosure may be designed to address at least one or all of these problems.

### SUMMARY

Briefly described, in select embodiments, the present disclosure of methods of legacy planning with gifts and heirs' property may generally include estimating a likelihood of an organization receiving a gift from a last will & testament and/or providing an heirs' property family tree software program. The step of estimating a likelihood of an organization receiving a gift from a last will & testament may generally include estimating a life expectancy range, and estimating a likelihood of removing the organization from the last will & testament. The step of providing an heir property family tree software program may generally include formulating the distributions of heir property, and visually displaying the distributions in a family tree display.

One feature may be that the estimated life expectancy range may be between one to four years.

Another feature may be that the life expectancy range may be tied to the national actuary table.

In select embodiments, the step of estimating a life expectancy range may include utilizing a life expectancy formula for computing a life expectancy range. In this embodiment, the life expectancy formula may include a factor for sex, a factor for race, a factor for marital status, a factor for age, a factor for adult children, a factor for children under the age of eighteen cared for, a factor for current employment status, a factor for the highest level of education, a factor for health conditions suffered from, a factor for exercise, a factor for seatbelt wear, and/or combinations thereof.

In select embodiments, the step of estimating a likelihood of removing the organization from the last will & testament may include utilizing a gift removal formula. In this embodiment, the gift removal formula may include a factor for decision making skills, a factor for likelihood of removing organization, a factor for organization positions, a factor for organization attendance, and/or combinations thereof. For example, if the organization is a church, the gift removal formula may include a factor for decision making skills, a factor for likelihood of removing church, a factor for church positions, a factor for church attendance, and/or combinations thereof.

In select embodiments, the step of estimating a likelihood of an organization receiving a gift from a last will & testament may include associating with an organization, providing estate planning services through the organization to its participants, and encouraging a gift to the organization for participants who are provided estate planning services. In these embodiments, the step of providing estate planning services through the organization may include providing an estate planning package. The estate planning package may include, but is not limited to, a last will & testament, a living will, a durable power of attorney, and/or combinations thereof.

One feature may be that the step of encouraging a gift to the organization for participants who are provided estate planning services may include providing announcements, rewards, or combinations thereof for participants who are provided estate planning services.

Another feature may be that the organization can be a church and the participants being church congregants, whereby the step of providing announcements, rewards, or combinations thereof may include, but is not limited to, sending a letter to church clergy of the church congregants participation, recognizing the church congregants in church, providing a plaque to the church clergy with the participating church congregants name on it to be hung in church, and/or combinations thereof.

In select embodiments, the step of formulating the distributions of heirs' property may include creating a database of state laws and regulations for calculating heirs' property in each state, entering the state for each heir property calculation, and calculating each heirs' property for each member of the family based on the state entered and the associated state laws and regulations of the state entered.

In select embodiments, the step of visually displaying the distributions in a family tree display may include providing a layered family tree display, wherein each member may be selected and the underlying heirs' property distributions for the selected member may be displayed.

In other select embodiments, the step of visually displaying the distributions in a family tree display may include color coding the family tree, whereby male living members are a first color, male died are a second color, female living are a third color, female died are a fourth color, and/or combinations thereof. In these embodiments, the color coding may include, but is not limited to, where the first color may be blue, the second color may be gray, the third color may be pink, and the fourth color may be green.

In other select embodiments, the step of visually displaying the distributions in a family tree display may include displaying a percentage of heirs' property for each formulated distribution.

These and other features of the methods of legacy planning with gifts and heirs' property will become more apparent to one skilled in the art from the prior Summary, and following Brief Description of the Drawings, Detailed Description, and Claims when read in light of the accompanying Detailed Drawings.

### BRIEF DESCRIPTION OF THE DRAWINGS

The present methods of legacy planning with gifts and heirs' property will be better understood by reading the Detailed Description with reference to the accompanying drawings, which are not necessarily drawn to scale, and in which like reference numerals denote similar structure and refer to like elements throughout, and in which:

FIG. 1 is a flow chart diagram of the method of legacy planning according to select embodiments of the instant disclosure;

FIG. 2 is a flow chart diagram of the process of estimating a likelihood of an organization receiving a gift from a will according to select embodiments of the instant disclosure;

FIG. 3 is a flow chart diagram of the process of estimating a likelihood of a church receiving a gift from a last will & testament according to select embodiments of the instant disclosure;

FIG. 4 is a flow chart diagram of the process of providing an heirs' property family tree software program according to select embodiments of the instant disclosure;

FIG. 5 is an example national actuary table according to select embodiments of the instant disclosure;

FIG. 6 is a diagram of a home page of the heirs' property family tree program according to select embodiments of the instant disclosure;

FIG. 7 is a diagram of an heirs' property family tree displayed on the heir property family tree program according to select embodiments of the instant disclosure;

FIG. 8 is a diagram of an underlying heirs' property family tree displayed from the heir property family tree from FIG. 7 according to select embodiments of the instant disclosure; and

FIG. 9 is another diagram of an underlying heir property family tree displayed from the heirs' property family tree from FIG. 7 according to select embodiments of the instant disclosure.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

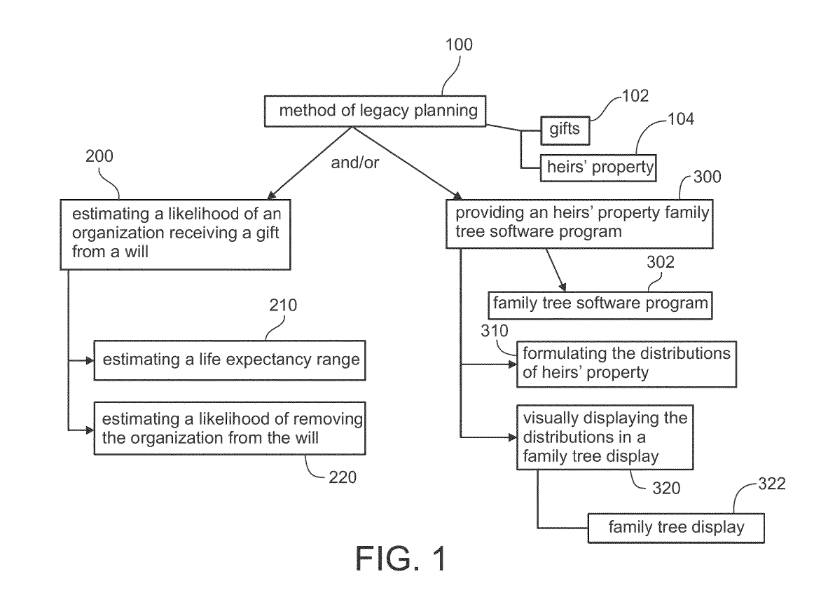

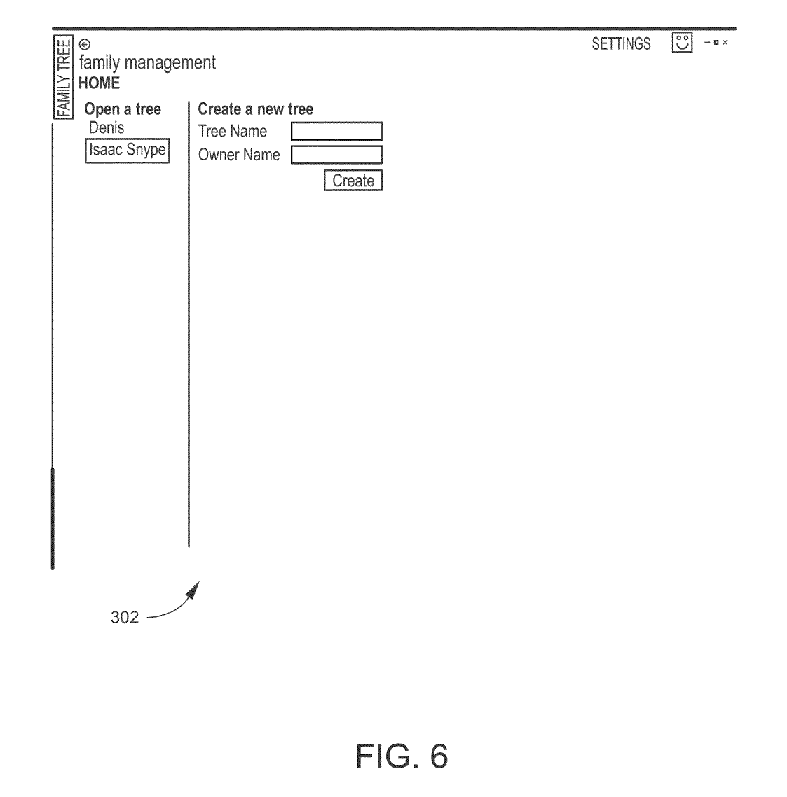

In describing the example embodiments of the present disclosure, as illustrated in FIGS. 1-9, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples, and are merely examples among other possible examples.

The instant disclosure is directed toward methods of legacy planning with gifts and heirs' property. Referring now to FIG. 1 by way of example, and not limitation, therein is illustrated an example embodiment of method 100 of legacy planning with gifts 102 and heirs' property 104. Method 100 may be for providing legacy planning at a reasonable cost, for encouraging legacy planning and gift giving, like to an organization 204 or church 206, for helping people in understanding heirs' property in legacy planning, for providing organizations 204, like churches 206, a means to encourage, promote, and provide means for members to contribute or donate gifts 102 when legacy planning, for providing organizations 204, like churches 206 a means for budgeting future gifts 102, the like, and/or combinations thereof.

For example, and clearly not limited thereto, method 100 may be directed toward improving the financial conditions of African American or other religious denominations while at the same time providing a service desperately needed among their congregants. Method 100 of legacy planning may encourage every congregation member to prepare a simple estate plan, (last will & testament, living will and power of attorney) through a website or other means at a reduced price in exchange for leaving a monetary gift 102 to their respective church 206. Nationally, the average cost of a last will & testament, living will and power of attorney may be between $1,200 to $2,500, depending on the state where you live. With the instant disclosure, the cost may be lower to encourage participation among dedicated congregation members and generate badly needed funds for their respective churches. Method 100 may include a team of experts equipped with the necessary skill set to work with any denomination through ensuring each congregant has estate planning package 230. Estate planning package 230 may include, but is not limited to, last will & testament 230A, living will 230B, power of attorney 230C, and/or combinations thereof to protect their family and church. Additionally, every congregant could consider leaving a monetary gift 102 to their church 206, or other organization 204, including, but not limited to, Historically Black Colleges & Universities (“HBCU”) alma mater, fraternity or sorority as well as their preferred national non profit organization such as the NAACP.

Briefly described, as shown in FIG. 1, in select embodiments the present disclosure of methods 100 of legacy planning with gifts 102 and heir property 104 may generally include step 200 of estimating a likelihood of an organization receiving a gift from a last will & testament and/or step 300 of providing an heirs' property family tree software program 302. The step 200 of estimating a likelihood of an organization receiving a gift from a last will & testament may generally include step 210 of estimating life expectancy range 212, and step 220 of estimating a likelihood of removing the organization from the last will & testament. Step 300 of providing an heirs' property family tree software program 302 may generally include step 310 of formulating the distributions of heirs' property, and step 320 of visually displaying the distributions in family tree display 322.

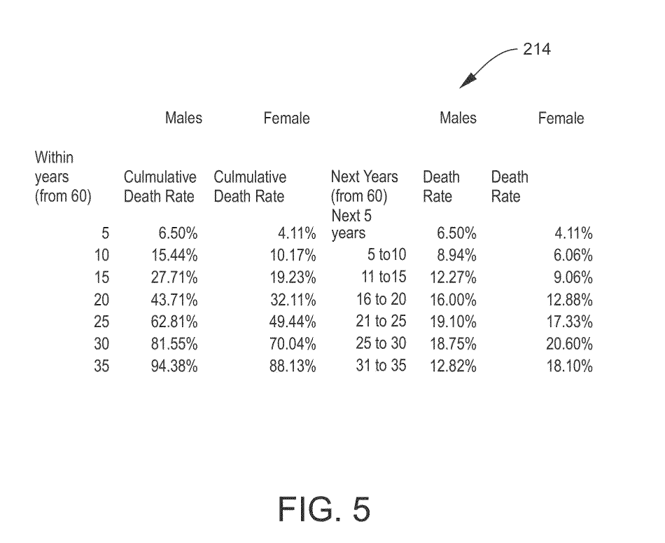

Life expectancy range 212 may be included in step 210 of estimating a life expectancy range. See FIGS. 1-3. Life expectancy range 212 may be for providing a range of when the member, congregant, etc. that is providing gift 102 (whether it be a willed gift or living gift) is expected to die. As such, life expectancy range 212 may be essential for organization 204, like church 206 in budgeting for future gifts and/or tithes. In one embodiment, life expectancy range 212 may be between one to four years, as represented by box 212. However, life expectancy range 212 may be any desired range of years. Life expectancy range 212 may be calculated by any means. In one embodiment, life expectancy range 212 may be tied to national actuary table 214, as shown in the example of FIG. 5. National actuary table 214 may be a table which shows, for each age, what the probability is that a person of that age will die before his or her next birthday, i.e. national actuary table 214 may show the probability of death. From this starting point, a number of inferences can be derived: the probability of surviving any particular year of age; and/or remaining life expectancy for people at different ages. The example national actuary table 214 shown in FIG. 5 may be from 2007. However, it may be desired to utilize the most up to date national actuary table 214 possible when utilizing the table for life expectancy range 212.

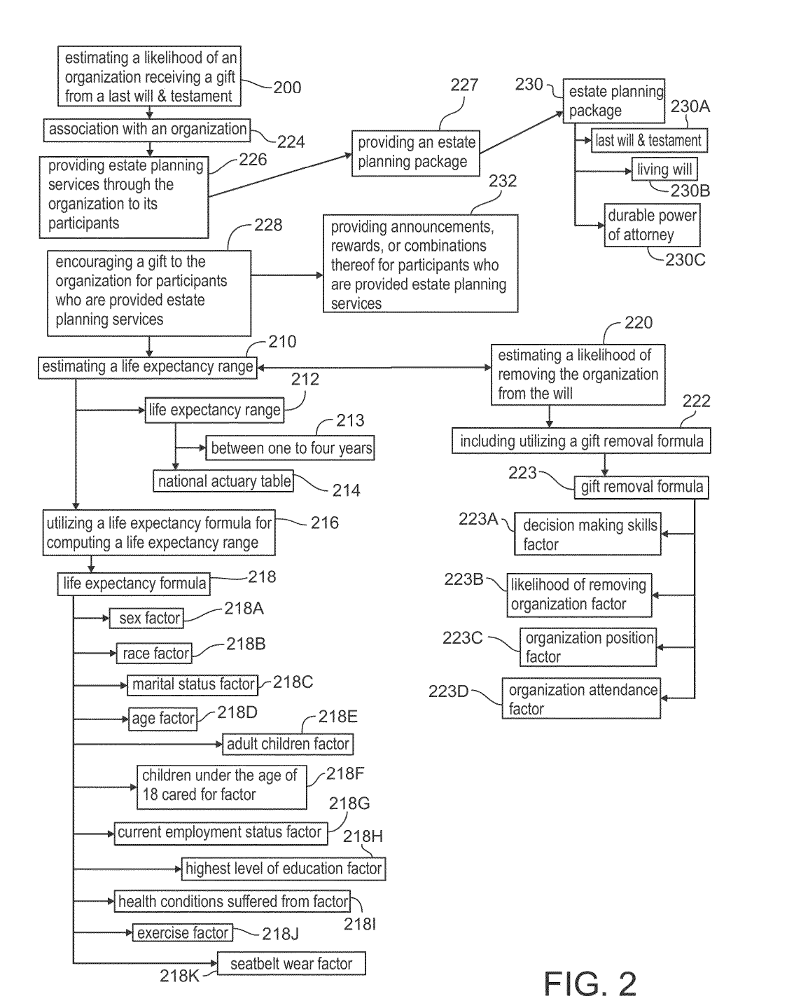

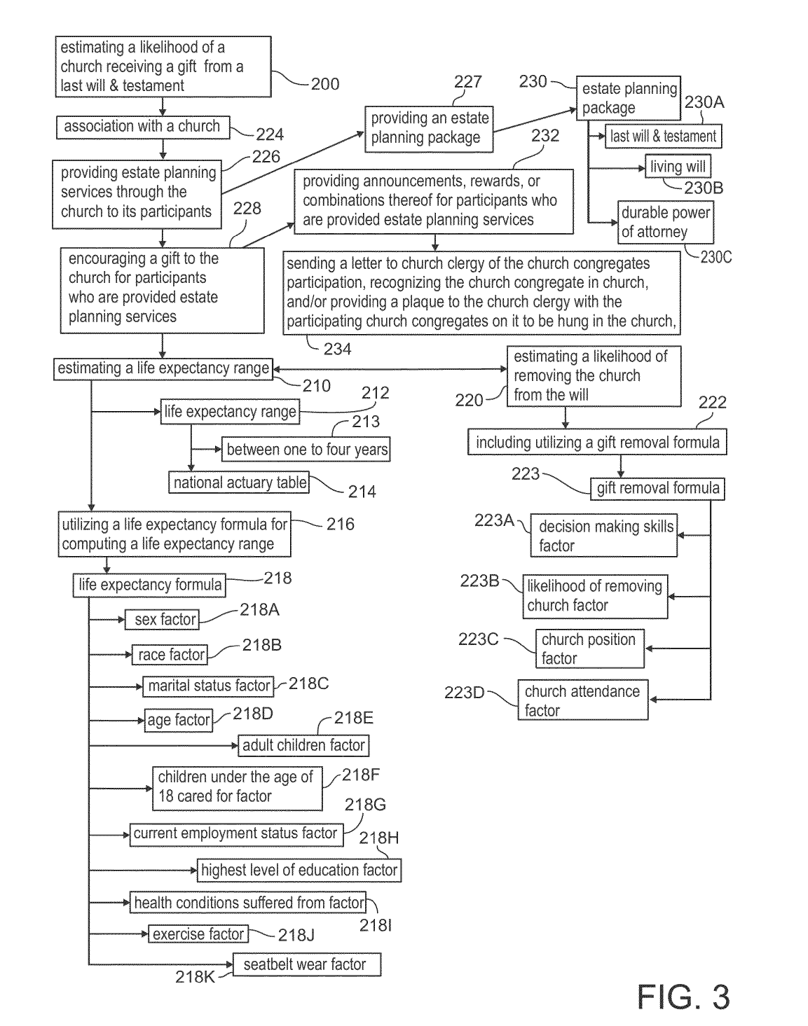

Referring to FIGS. 2-3, step 216 of utilizing life expectancy formula 218 may be included in select embodiments of step 210 of estimating life expectancy range 212. Step 216 may be for computing life expectancy range 212. Life expectancy formula 218 may be any desired formula for computing life expectancy range 212. In select embodiments, life expectancy formula 218 may include, but is clearly not limited thereto, sex factor 218A, race factor 218B, marital status factor 218C, age factor 218D, adult children factor 218E, children under the age of eighteen cared for factor 218F, current employment status factor 218G, highest level of education factor 218H, health conditions suffered from factor 218I, exercise factor 218J, seatbelt wear factor 218K, and/or combinations thereof. In one embodiment, life expectancy formula 218 may consist of sex factor 218A, race factor 218B, marital status factor 218C, age factor 218D, adult children factor 218E, children under the age of eighteen cared for factor 218F, current employment status factor 218G, highest level of education factor 218H, health conditions suffered from factor 218I, exercise factor 218J, and seatbelt wear factor 218K. As examples of determining factors 218A-218K, and clearly not limited thereto, the following questions may be utilized: My race is: a) African-American or b) White or Non African-American; My marital status is: a) Married or b) Not married/divorced/widowed; My age is: ______; I have adult children: y/n; I have children under the age of 18 who I care for: y/n; What is your current employment status?; The highest level of education I have is: a) High school diploma, b) Some college, c) College graduate or d) graduate school; Select the health conditions you suffer from: a) Heart disease/stroke, b) diabetes/high blood pressure, c) prostate/colon/breast cancer or d) No disease; How often do you exercise each week: a) None, b) Once a week or c) Three or more times per week; I wear a seatbelt when I drive: a) Every time I drive, b) Most of the time or c) Rarely; the like; and/or combinations thereof. Factors 218A-218K may be weighted equally or may be weighted differently depending on the desired formula used and the amount of weight each factor is considered by the user. Factors 218A-218K may stay constant or may change based on other factors.

Step 222 of utilizing gift removal formula 223 may be included in select embodiments of step 220 of estimating a likelihood of removing the organization from the last will & testament. See FIGS. 2-3. Step 222 of utilizing gift removal formula 223 may be for providing a percentage, range, or estimate of the likelihood the participant will remove the gift to the organization from the last will & testament. Gift removal formula 223 may be any desired formula for providing a percentage, range, or estimate of the likelihood the participant will remove the gift to the organization from the last will & testament. In select embodiments, gift removal formula 223 may include decision making skills factor 222A, likelihood of removing organization factor 222B, organization positions factor 222C, organizations attendance factor 222D, and/or combinations thereof. In one embodiment, gift removal formula 223 may consist of decision making skills factor 222A, likelihood of removing organization factor 222B, organization positions factor 222C, and organizations attendance factor 222D. For example, as shown in FIG. 3, if organization 204 may be church 206, gift removal formula 223 may include decision making skills factor 222A, likelihood of removing church factor 222B, church positions factor 222C, and/or church attendance factor 222D. As examples of determining factors 222A-222D, and clearly not limited thereto, the following questions may be utilized: Would you consider decision making skills: a) Strong once I make a decision it is final, b) Good but can be better or c) Weak, I can be influenced to change my mind; In your church do you hold any of the following positions: a) Deacon/Deaconess, b) Trustee, c) Auxillary/choir/etc. or d) None; How long have you attended church: a) All of my life, b) Majority of my life, c) Less than 10 years or d) New Church Member; the like; and/or combinations thereof. Factors 222A-222D may be weighted equally or may be weighted differently depending on the desired formula used and the amount of weight each factor is considered by the user. Factors 222A-222D may stay constant or may change based on other factors.

Step 224 of associating with organization 204, like church 206, may be included in select embodiments of step 220 of estimating a likelihood of an organization receiving a gift from a last will & testament. See FIGS. 2-3. Step 224 of associating with organization 204 may be for associating with organizations 204, like churches 206, in need of legacy planning services at reduced costs, organizations 204, like churches 206 in need of future gift estimations (like for budgeting purposes), and/or combinations thereof. Step 224 may include any steps, or means for associating with organization 204, including any contracts or the like.

Step 226 of providing estate planning services through organization 204, like church 206, to its participants may be included in select embodiments of step 220 of estimating a likelihood of an organization receiving a gift from a last will & testament. See FIGS. 2-3. Step 226 may be for providing estate planning services to organization 204, like church 206, including, but not limited to, providing estate planning package 230 with last will & testament 230A, living will 230B, and/or durable power of attorney 230C. In one embodiment, estate planning package 230 may consist of last will & testament 230A, living will 230B, and durable power of attorney 230C.

Step 228 of encouraging a gift to organization 204, like church 206, for participants who are provided estate planning services may be included in select embodiments of step 220 of estimating a likelihood of an organization receiving a gift from a last will & testament. See FIGS. 2-3. Step 228 may be for encouraging gifts, living gifts, tithes, the like, and/or combinations thereof to organization 204, like church 206. Step 228 may include any steps or means for encouraging a gift to organization 204. In one embodiment, step 228 may include step 232 of providing announcements, rewards, or combinations thereof for participants who are provided estate planning services. For example, as shown in FIG. 3, when organization 204 may be church 206 and participants 205 may be congregates 207, step 232 of providing announcements, rewards, or combinations thereof for participants who are provided estate planning services may include, but is clearly not limited to, step 234 of providing a plaque to the church clergy with the participating church congregates name on it to be hung in church, and/or combinations thereof. As such, the instant disclosure may include informing each donor's local pastor of their gift, which may be the reason that participants may be asked for the name and local address of their church and pastor's name.

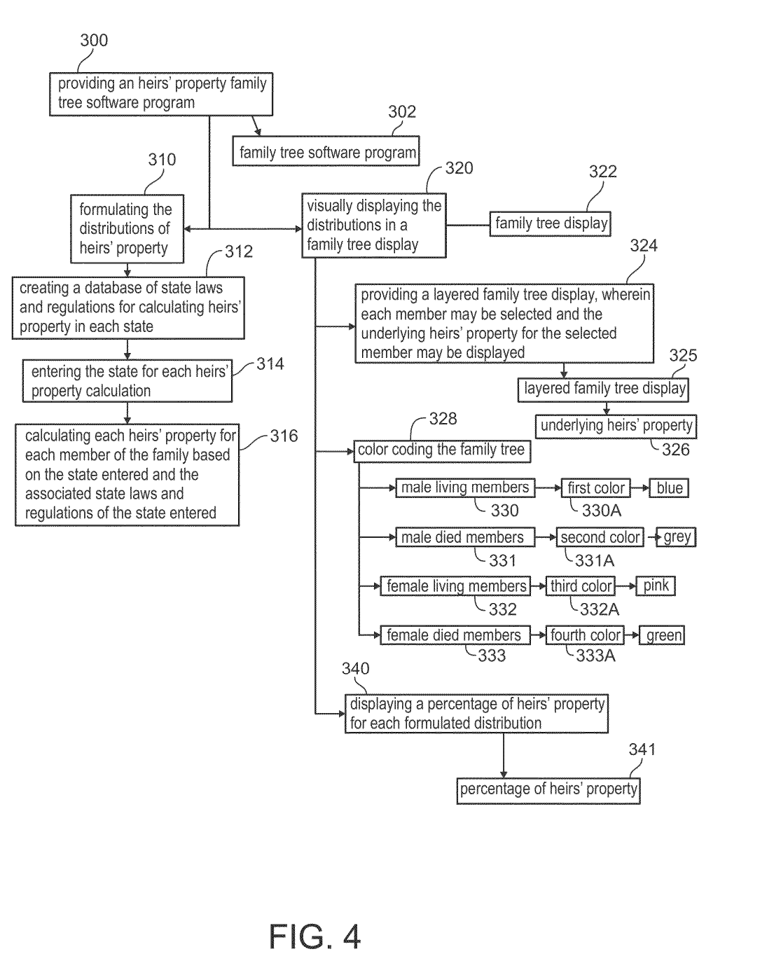

Referring now to FIGS. 4 and 6-9, step 300 of providing an heirs' property family tree software program 302 is shown and described. Heirs' property family tree software program 302 may be for aiding people in understanding heirs' property and may provide heirs' property distributions in an easy to read and understand format of family tree display 322. Heirs' property family tree software program 302 may include any desired features and/or formats for displaying heirs' property distributions in family tree display 322.

Referring now to FIG. 4, step 312 of creating a database of state laws and regulations for calculating heirs' property in each state may be included in select embodiments of step 310 of formulating the distributions of heirs' property. Step 312 may be for providing a database of all the laws and regulations for calculating heirs' property in each state, territory, or the like. Step 312 may include any required steps for creating, formulating, etc., a database of all the laws and regulations for each state. Step 312 of creating a database of state laws and regulations for calculating heirs' property in each state may include updating the database on a regularly basis (yearly, quarterly, monthly, etc.) or may include an automatic update feature for keeping the database up to date with changing laws and regulations.

Step 314 of entering the state for each heirs' property calculation may be included in select embodiments of step 310 of formulating the distributions of heirs' property. See FIG. 4. Step 314 may be for determining which state laws and regulations are to be applied for each heirs' property calculation. Step 314 may include any steps for entering the state. For example, upon creating family tree display 322, when each family member is entered into family tree display 322, a question may be asked about which state the member lived or resided upon death.

Step 316 of calculating each heirs' property for each member of the family based on the state entered and the associated state laws and regulations of the state entered may be included in select embodiments of step 310 of formulating the distributions of heirs' property. See FIG. 4. Step 316 may be for determining percentage 341 of heirs' property 104 for each member of the family based on the state laws and regulations of the state entered. Step 316 may include any program or calculation means for determining percentage 341 of heirs' property 104.

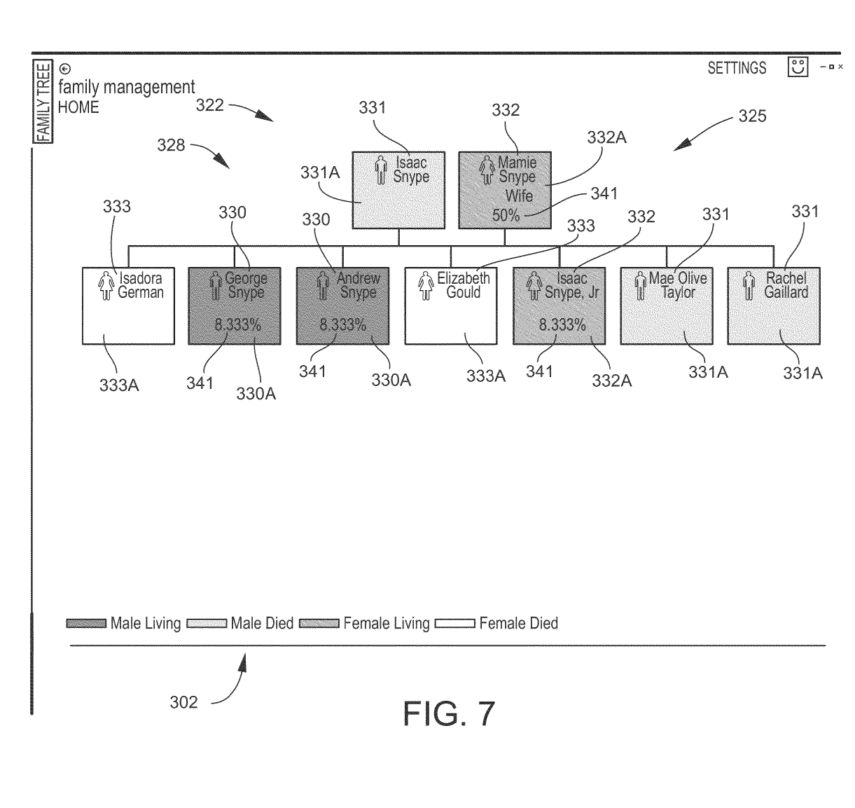

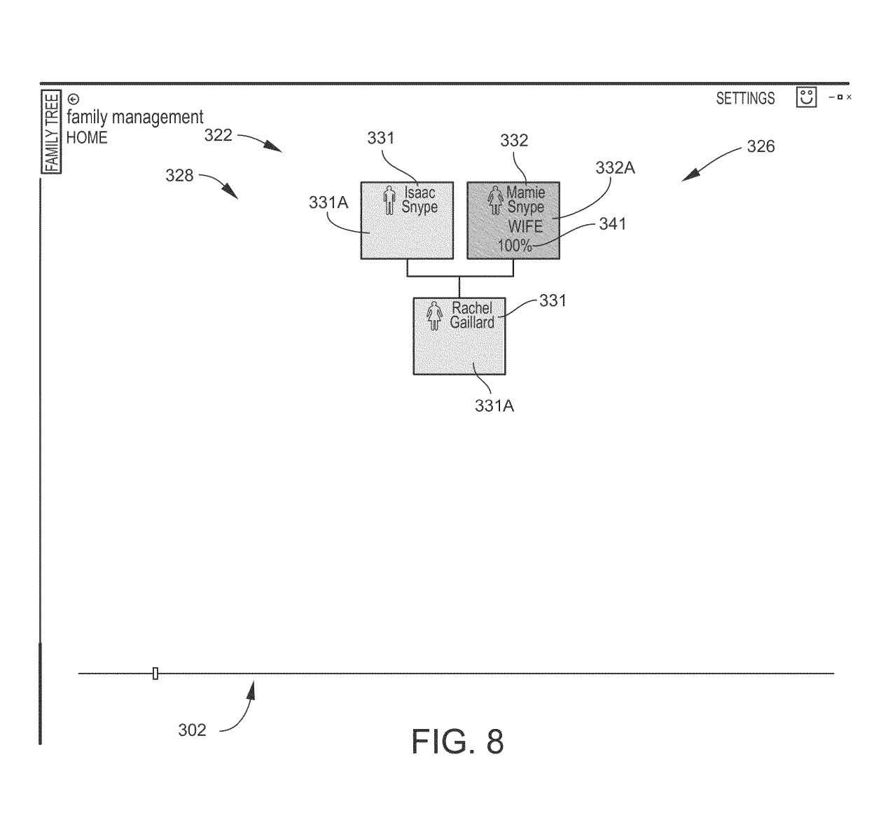

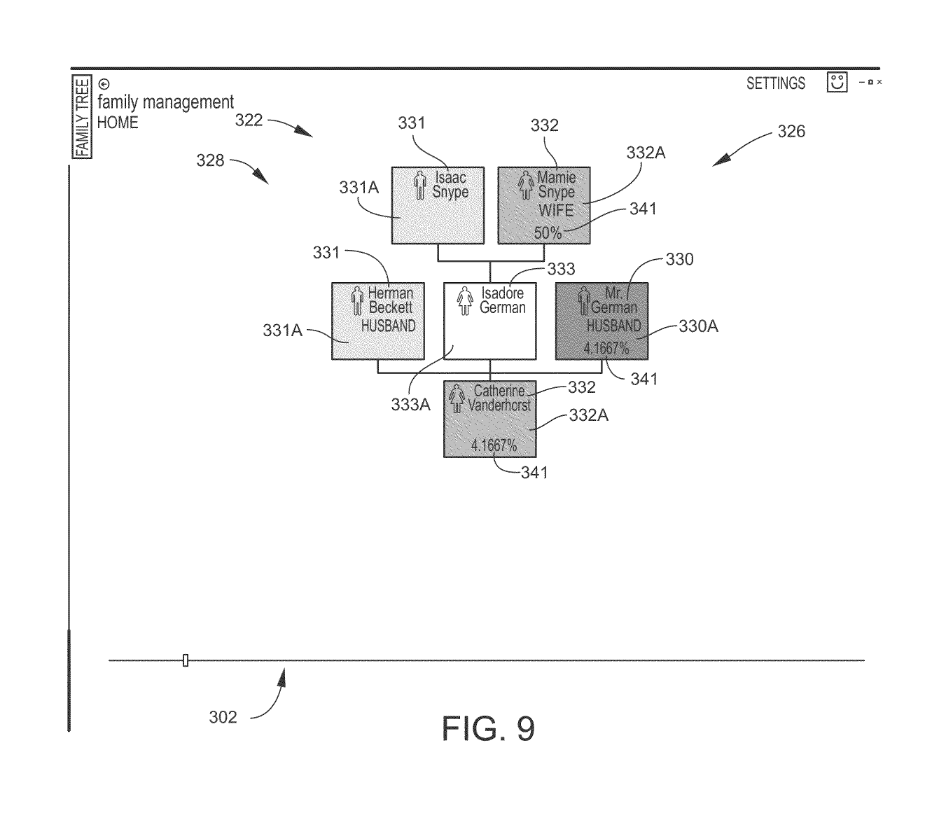

Step 324 of providing layered family tree display 325 may be included in select embodiments of step 320 of visually displaying the distributions in family tree display 322. See FIG. 4. Step 324 may be for providing an underlying heir property 326 family tree display for each family member. Wherein, each member may be selected and the underlying heir property 326 for the selected member may be displayed. See FIGS. 8-9, which show the underlying heir property 326 for members Rachel Gaillard (FIG. 8) and Isadora German (FIG. 9) of the layered family tree 325 of family tree display 322 from FIG. 7.

Step 328 of color coding of family tree display 322 may be included in other select embodiments of step 320 of visually displaying the distributions in family tree display 322. Step 328 may be for providing an easy visualization of each distinct member of family tree display 322. Step 328 may include any color coding scheme. In select embodiments, male living members 330 may be first color 330A, male died members 331 may be second color 331A, female living members 332 may be third color 332A, female died members may be fourth color 333A, and/or combinations thereof. For example, and clearly not limited thereto, in these color coded embodiments, first color 330A may be blue, second color 331A may be gray, third color 332A may be pink, and fourth color 333A may be green.

Step 340 of displaying percentage 341 of heirs' property 104 for each formulated distribution may be included in select embodiments of step 320 of visually displaying the distributions in family tree display 322. See FIGS. 4 and 7-9. Step 340 may include displaying percentage 341 of heir property 104 in the appropriate family tree box of each formulated heir property distribution, including but not limited to, below the persons name, as shown in FIGS. 7-9.

The foregoing description and drawings comprise illustrative embodiments. Having thus described example embodiments, it should be noted by those skilled in the art that the within disclosures are example only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein, but is limited only by the following claims.

What is claimed is:

1. A method of legacy planning comprising:
estimating a likelihood of an organization receiving a gift from a will including:
estimating a life expectancy range; and
estimating a likelihood of removing said organization from said last will & testament;
providing an heirs' property family tree software program, said heirs' property family tree software program including:
formulating distributions of heirs' property; and
visually displaying said distributions in a family tree display; or
combinations thereof.

2. The method of legacy planning of claim 1 comprising:
estimating a likelihood of an organization receiving a gift from a last will & testament including:
estimating a life expectancy range; and
estimating a likelihood of removing said organization from said last will & testament; and
providing an heirs' property family tree software program, said heirs' property family tree software program including:
calculating distributions of heir property; and
visually displaying said distributions in a family tree display.

3. The method of legacy planning of claim 1 wherein said estimated life expectancy range being between one to four years.

4. The method of legacy planning of claim 1 wherein said life expectancy range being tied to a national actuary table.

5. The method of legacy planning of claim 1 wherein said step of estimating a life expectancy range including utilizing a life expectancy formula for computing the life expectancy range, said life expectancy formula comprising:
a factor for sex;
a factor for race;
a factor for marital status;
a factor for age;
a factor for adult children;
a factor for children under the age of eighteen cared for;
a factor for current employment status;
a factor for the highest level of education;
a factor for health conditions suffered from;
a factor for exercise;
a factor for seatbelt wear; or
combinations thereof.

6. The method of legacy planning of claim 1 wherein said step of estimating a likelihood of removing said organization from said last will & testament including utilizing a gift removal formula, said gift removal formula comprising:
a factor for decision making skills;
a factor for likelihood of removing organization;
a factor for organization positions;
a factor for organization attendance; or
combinations thereof.

7. The method of legacy planning of claim 1 wherein said step of estimating a likelihood of an organization receiving a gift from a last will & testament further including:
associating with the organization;
providing estate planning services through said organization to its participants; and
encouraging a gift to said organization for participants who are provided estate planning services.

8. The method of legacy planning of claim 7 wherein said step of providing estate planning services through said organization including providing an estate planning package comprising:
a last will & testament;
a living will; and
a durable power of attorney.

9. The method of legacy planning of claim 7 wherein said step of encouraging a gift to said organization for participants who are provided estate planning services including providing announcements, rewards, or combinations thereof for participants who are provided estate planning services.

10. The method of legacy planning of claim 9 wherein said organization being a church and said participants being church congregants, whereby said step of providing announcements, rewards, or combinations thereof including sending a letter to church clergy of the church congregants participation, recognizing the church congregant in church, providing a plaque to the church clergy with the participating church congregants name on it to be hung in church, or combinations thereof.

11. The method of legacy planning of claim 1 wherein said step of formulating the distributions of heirs' property including:
creating a database of state laws and regulations for calculating heirs' property in each state;
entering the state for each heirs' property calculation; and
calculating each heirs' property for each member of the family based on the state entered and the associated state laws and regulations of said state entered.

12. The method of legacy planning of claim 1 wherein said step of visually displaying said distributions in a family tree display including providing a layered family tree display, wherein each member may be selected and the underlying heirs' property for the selected member may be displayed.

13. The method of legacy planning of claim 1 wherein said step of visually displaying said distributions in a family tree display including color coding the family tree display, whereby male living members are a first color, male died are a second color, female living are a third color, female died are a fourth color, and combinations thereof.

14. The method of legacy planning of claim 1 wherein said step of visually displaying said distributions in a family tree display including displaying a percentage of heir property for each formulated distribution.

15. A method of estimating a likelihood of an organization receiving a gift from a last will & testament comprising:
estimating a life expectancy range; and
estimating a likelihood of removing said organization from said last will & testament.

16. The method of estimating a likelihood of an organization receiving a gift from a last will & testament of claim 15 wherein:
said estimated life expectancy range being between one to four years;
said life expectancy range being tied to a national actuary table;
said step of estimating a life expectancy range including utilizing a life expectancy formula for computing the life expectancy range, said life expectancy formula comprising:
a factor for sex;
a factor for race;
a factor for marital status;
a factor for age;
a factor for adult children;
a factor for children under the age of eighteen cared for;
a factor for current employment status;
a factor for the highest level of education;
a factor for health conditions suffered from;
a factor for exercise;
a factor for seatbelt wear; or
combinations thereof;
said step of estimating a likelihood of removing said organization from said last will & testament including utilizing a gift removal formula, said gift removal formula comprising:
a factor for decision making skills;
a factor for likelihood of removing organization;
a factor for organization positions;
a factor for organization attendance; or
combinations thereof; or
combinations thereof.

17. The method of estimating a likelihood of an organization receiving a gift from a last will & testament of claim 15 further including:
associating with the organization;
providing estate planning services through said organization to its participants;
encouraging a gift to said organization for participants who are provided estate planning services;
wherein said step of providing estate planning services through said organization including providing an estate planning package comprising:
a last will & testament;
a living will; and
a durable power of attorney;
wherein said step of encouraging a gift to said organization for participants who are provided estate planning services including providing announcements, rewards, or combinations thereof for participants who are provided estate planning services; or
combinations thereof.

18. The method of estimating a likelihood of an organization receiving a gift from a last will & testament of claim 17 wherein said organization being a church and said participants being church congregates, whereby said step of providing announcements, rewards, or combinations thereof including sending a letter to church clergy of the church congregates participation, recognizing the church congregate in church, providing a plaque to the church clergy with the participating church congregates name on it to be hung in church, or combinations thereof.

19. A method of providing an heirs' property family tree software program, said heirs' property family tree software program including:
formulating distributions of heirs' property; and
visually displaying said distributions in a family tree display.

20. The method of providing an heirs' property family tree software program of claim 19 wherein:
said step of formulating the distributions of heirs' property including:
creating a database of state laws and regulations for calculating heir property in each state;
entering the state for each heirs' property calculation; and
calculating each heirs' property for each member of the family based on the state entered and the associated state laws and regulations of said state entered;
said step of visually displaying said distributions in a family tree display including providing a layered family tree display, wherein each member may be selected and the underlying heirs' property for the selected member may be displayed;
said step of visually displaying said distributions in a family tree display including color coding the family tree display, whereby male living members are a first color, male died are a second color, female living are a third color, female died are a fourth color, and combinations thereof;
said step of visually displaying said distributions in a family tree display including displaying a percentage of heirs' property for each formulated distribution; or
combinations thereof.
